(19) United States
(12) Patent Application Publication
(10) Pub. No.: US 2010/0203907 A1
(43) Pub. Date: Aug. 12, 2010

(54) METHOD AND SYSTEM FOR PROVIDING 3G SERVICES BY SHORT MESSAGE SERVICE

(76) Inventor: Yong Jin Kim, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/528,315

(22) PCT Filed: Feb. 20, 2008
(86) PCT No.: PCT/KR08/00977

§ 371 Date: Mar. 8, 2010

(30) Foreign Application Priority Data
Feb. 21, 2007 (KR) 10-2007-00117539
Nov. 23, 2007 (KR) 10-2007-0120150

(51) Int. Cl. H04W 4/12

(52) U.S. Cl. 455/466

(57) ABSTRACT

A method of providing third-generation (3G) communication services using Short Message Service (SMS) messages is disclosed. When there is a request for a communication call to a called terminal by a calling terminal, a service server constructs an SMS message including the called terminal's reception information and 3G content information, and transmits it to the calling terminal. The calling terminal displays the called terminal's reception information, and activates and displays supportable service items. When the voice communication is selected from the service items, the voice communication is performed with the called terminal. When the video communication is selected, the video communication is performed with the called terminal. When the 3G content is selected, the service server in which corresponding 3G content is located is accessed, packet data is transmitted and received, and voice communication is performed with the called terminal.

### TECHNICAL FIELD

The present invention relates to a method and system for providing third-generation (3G) services using Short Message Service (SMS) messages, which extends a method of access to 3G services, which includes video communication and is provided using a separate video communication key in a conventional Wideband Code Division Multiple Access (WCDMA) network environment and a 1× Evolution-Data Optimized (EV-DO) network environment, to a voice communication key, so that the exposure of the 3G services to users increases, and which provides reception status information related to the use of the 3G services and 3G content information, previously registered by a called party, to a calling party before a call is connected, so that the calling party suitably selects video communication and 3G services depending on reception status and uses it more conveniently.

### BACKGROUND ART

Conventional video phone service provided over a conventional WCDMA network is circuit-switched type service based on the H.324M protocol, and conventional video phone service provided over a 1×EV-DO network is packet-switched type service based on the H.323 protocol. When a calling party enters a separate video communication key together with a called number using a terminal which supports circuit-switched or packet-switched video phone service within an area or a country included in the coverage of video communication, the calling terminal sends a video communication call. In this case, only when a called party must possess a terminal which supports the circuit-switched or packet-switched video phone service and be located within the video communication coverage, a call path will be set up between the terminals in response to the video communication call, so that video communication can be used through a multimedia communication control protocol negotiation (H.245).

### DISCLOSURE

### Technical Problem

In the case in which a called terminal, which received a video call in a conventional network environment, does not support video communication or it is located in an area outside of service coverage, the connection of video communication is not realized. In the case in which a called party, who possesses a terminal that supports video communication, cannot perform video communication or receives a request for video communication from a specific party with whom communication is undesirable or an unknown calling party, the case where the called party does not answer the request may often occur. Since the connection of the video communication, which allows communication to be realized while opposite parties view each other's faces, is affected by the state of the called terminal or the intention of the called party, the probability of connection failure is higher, compared to when voice communication is attempted, and thus it is inconvenient for users to use video communication.

Therefore, in a conventional method, in which video communication is attempted by selecting a separate video communication key while the state of a called terminal or the intention of a called party is not known, a user worries about whether connection is possible from the time that the user selects a video communication key, so that the user seldom selects the video communication key, thereby causing the overall use rate of video communication to be decreased.

An object of the present invention is, when a calling party attempts to send a voice call or a video call using a terminal which supports a network environment, such as a WCDMA network environment or a 1×EV-DO network environment, to provide information required to support 3G services including video communication for the call, that is, reception status information related to 3G services, such as a called terminal's 3G service support availability information, the called terminal's 3G coverage availability information and video communication reception availability information previously set by a called party, and 3G content information previously registered by the called party, to a calling terminal using an SMS message in compliance with a specific standard before the connection of the call, so that the calling party recognizes reception status related to the use of 3G services immediately after the calling party sends the voice call or the video call, inquires about 3G services that can be supported, properly selects usable 3G services including voice communication based on the situation and uses them.

### Technical Solution

In order to accomplish the above object, the present invention provides a method of providing third-generation (3G) communication services using Short Message Service (SMS) messages, including a first step of, when there is a request for a communication call to a specific called terminal by a calling terminal, a service server constructing an SMS message which includes the called terminal's reception information and 3G content information, and transmitting the SMS message to the calling terminal; a second step of the calling terminal displaying the called terminal's reception information, and activating and displaying supportable service items among service items including voice communication, video communication, and 3G content; and a third step of, when the voice communication is selected from the service items, performing the voice communication with the called terminal, when the video communication is selected, performing the video communication with the called terminal, and, when the 3G content is selected, accessing the service server in which corresponding 3G content is located, transmitting and receiving packet data and performing voice communication with the called terminal.

The first step includes a step of the calling terminal requesting a communication call from the specific called terminal; a step of a Home Location Register (HLR) inquiring about the called terminal's reception information and providing it to the service server; and a step of the service server constructing an SMS message which includes the called terminal's video communication reception availability information which is internally registered, 3G content information and the received reception information, and then transmitting the SMS message to the calling terminal.

The SMS message is realized in compliance with a Tele-service Identification (TID) standard. Further, the SMS message is transmitted through a traffic channel connected between a base station and the calling terminal when the calling terminal sends a call.

The method further includes, when the 3G content is selected at the third step, a step of the calling terminal accessing the service server in which the 3G content is located based on address information included in the 3G content information; a step of the calling terminal performing voice communication with the called terminal; and a step of the calling terminal transmitting and receiving packet data to and from the service server.

Further, the method further includes, when the 3G content is selected at the third step, a step of the calling terminal accessing the service server in which the 3G content is located based on address information included in the 3G content information; a step of the service server transmitting the SMS message, including the 3G content information, to the called terminal; a step of the calling terminal performing the voice communication with the called terminal; a step of the calling terminal accessing the service server in which the 3G content is located based on address information included in the 3G content information; and a step of the calling terminal and the called terminal transmitting and receiving packet data to and from the service server, respectively.

Further, the request for a communication call includes a request for a voice call and a request for a video call, and the reception information includes the called terminal's 3G service support availability information and 3G coverage availability information.

Further, at the first step, the SMS message further includes the called terminal's video communication reception availability information, and, at the second step, the calling terminal displays reception information including the called terminal's video communication reception availability information.

Further, at the second step, the calling terminal does not activate the service items corresponding to the video communication service when the called terminal cannot receive the video communication.

The present invention provides a system for providing 3 G communication services using SMS messages, including a called terminal for performing voice communication, video communication and data communication with a calling terminal; an HLR for storing reception information including the called terminal's 3G service support availability information and 3G coverage availability information; a service server for constructing an SMS message including the called terminal's video communication reception availability information, the called terminal's reception information and 3G content information, and then transmitting the SMS message to the calling terminal; and a calling terminal for, when the SMS message is received, displaying the called terminal's video communication reception availability information and the reception information by running an installed program, also activating and displaying one or more supportable service items among service items which include voice communication, video communication and 3G content, and providing voice communication, video communication, or 3G content services for the called terminal in response to selection of one of the service items.

The service server includes a service user Database (DB) for storing information about users who have subscribed to 3G services; a video communication reception status DB for storing user terminals' video communication reception availability information; a 3G content DB for storing 3G content registered by the users; an SMS message processing unit for generating an SMS message which includes video communication reception availability information, 3G content information, and a called terminal's reception information; an SMS message transmission unit for transmitting the generated SMS message to a designated calling terminal through an SMS Message Center (SMSC); a data processing unit for performing interfacing for access processing when the calling terminal or the called terminal attempts to access the 3G content; a data transmission unit for transmitting data, on which the access processing is performed by the data processing unit, to the calling terminal or the called terminal; and a central controller for transmitting and receiving information to and from the HLR and the SMSC by processing interfacing therebetween, and performing transmission control on the SMS message.

### ADVANTAGEOUS EFFECTS

The present invention greatly expands a method of access to video communication and specific 3G services, which can be used only by selecting a video communication key in a conventional method, so that access can be made using a voice communication key, and allows a proper communication method and 3G services to be conveniently selected and used depending on reception status by providing video communication availability information and additional 3G service availability information to voice communication users, thereby activating the use of 3G services including video communication.

### DESCRIPTION OF DRAWINGS

FIG. 1 is a block diagram showing a system for providing 3G services using SMS messages according to the present invention;

FIG. 2 is a view showing an operational process between respective blocks of the system for providing 3G services using SMS messages according to an embodiment of the present invention;

FIG. 3 is a view showing an operational process between respective blocks of a system providing only 3G content according to another embodiment of the present invention;

FIG. 4 is a diagram showing a service server according to an embodiment of the present invention; and

FIG. 5 is a flowchart showing an operational process of a terminal according to an embodiment of the present invention.

### MODE FOR INVENTION

Embodiments of the present invention will be described in detail with reference to the attached drawings below.

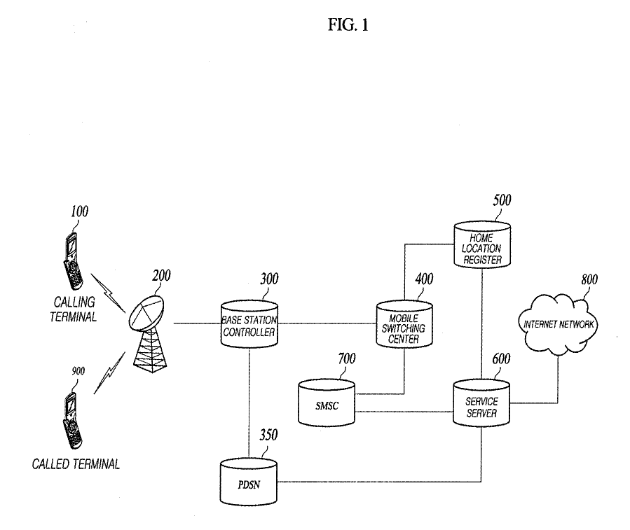

FIG. 1 is a block diagram showing a system for providing 3G services using SMS messages according to the present invention.

The system of a mobile communication network for the present invention includes a calling terminal 100, a called terminal 900, a Home Location Register (HLR) 500, and a service server 600, and further includes a base station 200, a base station controller 300, a Packet Data Serving Node (PSDN) 350, a mobile switching center 400, and a Short Message Service Center (SMSC) 700.

The calling terminal 100 and the called terminal 900 support general 3G services including video communication, in a WCDMA network or 1×EV-DO network environment, convert the content of an SMS message into a menu in compliance with a defined procedure by running a program, installed in or downloaded to a terminal, when the SMS message in compliance with a predetermined standard is received, and perform data communication by accessing a specific service server.

The base station (base transceiver station/radio transceiver subsystem) 200 wirelessly accesses the calling terminal and the called terminal, and transmits and receives data through a wireless channel.

The base station controller (radio network controller) 300 performs a function of signal processing for wireless communication by accessing the base station 200 and the mobile switching center 400 in a wired manner. The mobile switching center 400 performs a procedure of processing a voice call and a video call at the request of the calling terminal 100.

The HLR (Home Location Register) 500 manages information about various types of supplementary service subscribers by storing reception information including the service subscriber terminal's 3G service support availability information and the terminal's 3G coverage availability information.

The service server 600 constructs an SMS message, in compliance with a specific standard, which includes the called terminal's 3G service support availability information, the called terminal's 3G coverage availability information, and called user-set video communication reception availability information, and 3G content information, which are provided from the HLR 500, transmits the SMS message to the calling and called terminals, and then transmits the content-related data to the calling and called terminals through a data channel at the request of the calling and called terminals while storing and managing the 3G content.

The SMSC (Short Message Service Center) 700 accesses the service server 600 and the mobile switching center 400, and then transmits the SMS message, in compliance with a specific standard, generated by the service server 600 to the calling and called terminals.

The PDSN (Packet Data Serving Node) 350 accesses the service server 600 and the base station controller 300, and processes data in the form of a packet transmitted between the service server 600 and the calling and called terminals. The Internet network 800 provides an environment in which a caller can inquire about and register 3G content using an Internet record medium.

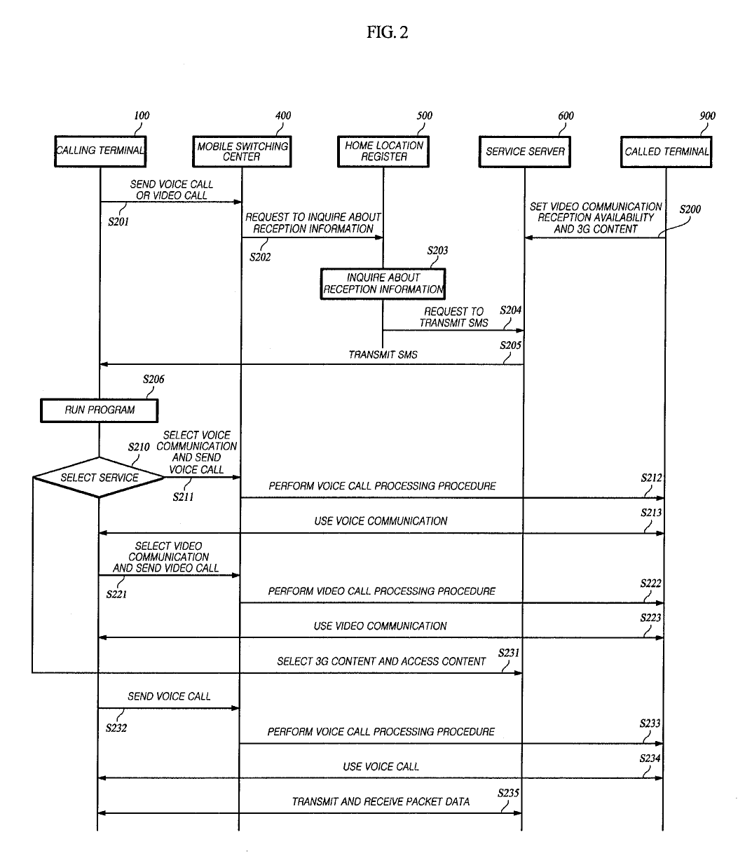

FIG. 2 is a view showing an operational process between respective blocks of the system for providing 3G services using SMS messages according to an embodiment of the present invention.

First, the called terminal 700 sets and registers called terminal's video communication reception availability information and 3G content information in the service server 600 connected to the HLR 500 at step S200.

The calling terminal 100 sends a communication call at the request of a user at step S201. The communication call is a communication request call, including a voice call and a video call. In response to an attempt to send a call, the mobile switching center 400 requests reception information from the HLR 500 at step S202, and the HLR 500 inquires about the reception information at step S203. The reception information includes called terminal 900's 3G service support availability information and 3G service coverage availability information. When reception information is transmitted to the service server 600, the transmission of an SMS message in compliance with a specific standard is requested at step S204. Thereafter, the service server 600 constructs an SMS message in compliance with a specific standard by inserting video communication reception availability information and 3G content information which are directly set by a called party into the called terminal's 3G service support availability information, provided from the HLR 500, and then transmits the SMS message to the calling terminal at step S205.

The SMS message in compliance with a specific standard functions to run a program, previously stored in the calling terminal 100, using a specific standard of standards for SMS message unique Identification (ID), that is, Tele-Service ID (TID). The SMS message, including data corresponding to 80 bytes, like a general SMS message, can be provided to the program of the terminal.

Further, since the SMS message is transmitted through a sending traffic channel connected between the base station 200 and the calling terminal 100 in order to perform a procedure for interfacing wireless communication based on the called party's attempt to send a call, a traffic channel is not required to be additionally established for the transmission of the SMS message. Therefore, the transmission rate of an SMS message is greatly improved, so that the calling terminal 100 receives the SMS message immediately after the SMS message is transmitted. Accordingly, the conventional problem of an SMS message, that is, delayed arrival, can be solved, thereby enabling the service of the present invention to be realized using SMS messages.

The calling terminal 100, which received the SMS message, runs a stored program at step S206, displays 3G-related reception status information, such as the called terminal 700's 3G service support availability information and 3G service coverage availability information, and called party's video communication reception availability information, included in the SMS message, on a screen, constructs a selection menu for 3G content registered by a called user, together with a menu for voice communication and video communication on the screen, and activates a menu for service which can be supported based on the 3G-related reception status information, so that the called party can select and use one of voice communication, video communication, and 3G services at step S210.

If the calling party attempts voice communication connection when video communication and 3G content cannot be used, the calling terminal 100 attempts to send a voice call to a called number, designated by the calling party at step S201, at step S211. Thereafter, the mobile switching center 400 performs a voice call processing procedure at step S212. A call path is connected between calling and called terminals based on the voice call processing procedure, so that voice communication is realized at step S213. If the calling party attempts video communication connection when video communication can be realized, the calling terminal 100 attempts to initiate a video call with the called number at step S221. Thereafter, the mobile switching center 400 performs a video call processing procedure at step S222. A call path is connected between the calling and called terminals based on the video call processing procedure and protocol negotiation is completed in compliance with a standard for video communication, so that video communication is realized at step S223. If the calling party selects 3G content when the 3G content can be used, the calling terminal 100 accesses the 3G content located in the service server 600 based on information about the address of the 3G content included in the SMS message at step S231, and then sends a voice call to the called number at step S232. Therefore, the mobile switching center 400 performs the voice call processing procedure at step S233, and a call path is connected between the calling and called terminals based on the voice call processing procedure, so that voice communication is realized at step S234. The calling terminal 100 which accessed the 3G content transmits and receives packet data to and from the service server 600, thereby enabling the calling party to use the 3G content while performing the voice communication at step S235.

A method of, when a calling party attempts to sends a voice call or a video call, providing service regardless of reception status related to the use of 3G services has been described in the present invention. However, the service server 600 may determine the called terminal's 3G support availability information and video communication reception availability information, and allow the service of the present invention to be provided only when it is difficult for a called party to receive video communication, so that a calling party recognizes the reason why the connection of video communication is not realized, and then uses voice communication or 3G content service. In the case in which video communication is supported, the video communication can be directly used without using the service of the present invention. In the case in which the HLR 500 determines video communication support availability, the service server 600 must provide video communication reception availability information to the HLR 500 whenever user-set video communication reception availability information changes.

The 3G content may be divided into stand-alone content, by which a calling party independently uses still images, moving images, music, games, and character bulletin boards, which are registered by a called party, while voice communication is used, and interactive content, by which a calling party chats and plays network games with a called party while voice communication is used.

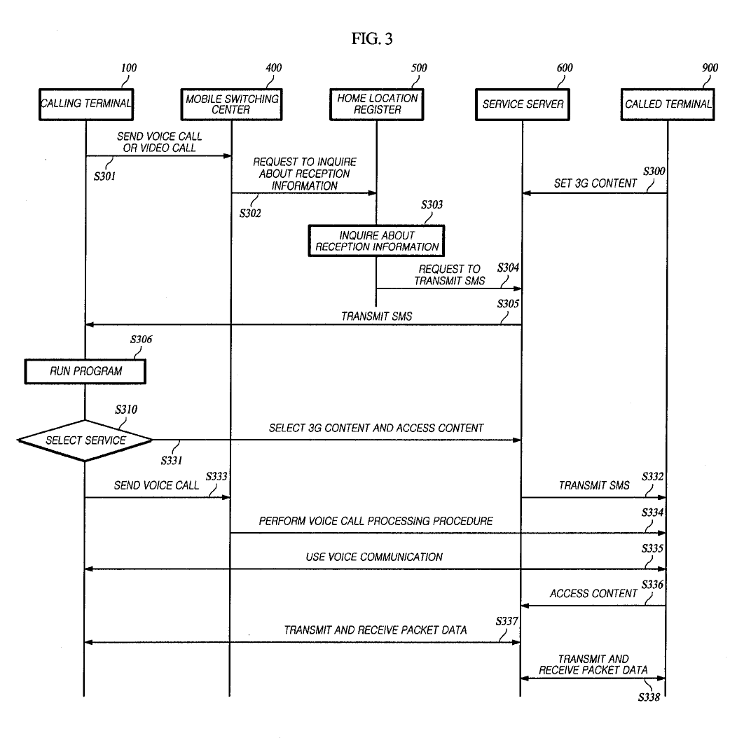

FIG. 3 is a view showing another embodiment of the present invention, that is, an operational process between respective blocks of the system for supporting a method of a calling party and a called party interactively using interactive content of the 3G content, registered by a service user.

Since the procedure of the calling terminal 100 sending a voice call or a video call, the service server 600 transmitting the specific SMS message to the calling terminal 100, and the calling terminal 100 running an installed program, thereby enabling a calling party to select the 3G interactive content (steps from S300 to S310) is the same as the steps from S200 to S210 of FIG. 2, a duplicated description will be omitted.

In the case in which the calling party selects 3G content, the calling terminal 100 accesses the 3G content located in the service server 600 based on the information about the address of the 3G content included in the SMS message at step S331, and the service server 600 transmits the SMS message including the information about the address of the content to the called terminal 900 at step S332.

The calling terminal 100 which accessed the content sends a voice call to the called number at step S333, and the mobile switching center 400 performs a voice call processing procedure at step S334, so that a call path is connected between the calling and called terminals based on the voice call processing procedure, thereby realizing voice communication at step S335.

Meanwhile, the called terminal 900 that received the SMS message confirms the intention of a called party for the use of the content, and then, if the called party wants to use the content, accesses the content based on the information about an address which is included in the SMS message at step S336. Upon the calling party's request for the use of the content, the calling and called terminals access the same 3G interactive content and then transmit and receive packet data with each other at steps S337 and S338, so that the calling party and the called party are enabled to use the content with each other while performing voice communication.

In the present invention, a method has been described in which a calling party and a called party use 3G interactive content, registered by the called party, with each other at a request by the calling party for the use of the content. However, even in the case in which a user who has registered content sends a call, the user can use the content with an arbitrary called party by selecting the content registered by himself/herself while performing voice communication.

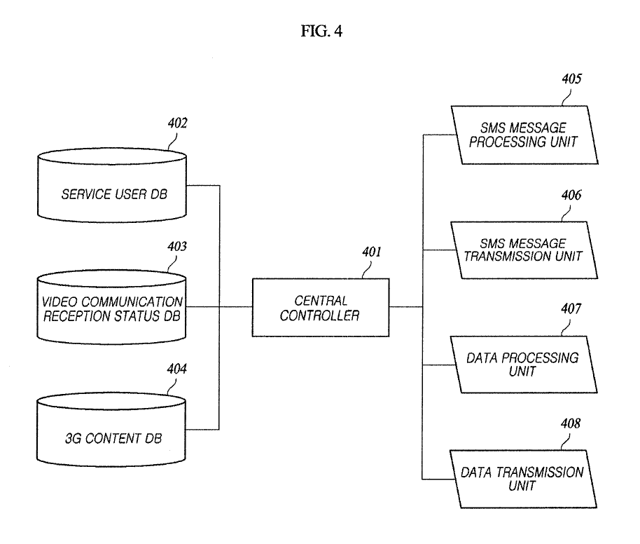

FIG. 4 is a block diagram showing the configuration of the service server 600 according to an embodiment of the present invention.

The service server 600 according to the present invention is connected with the HLR 500, the SMSC 700, the Internet network 800 and the PDSN 350 so as to provide services, and configured to include a central controller 401 for performing interfacing and central controlling, such as instructing a process by transmitting information provided from the connected systems to the units included in the service server 600 in compliance with defined service requirements, and requesting a process by transmitting information, provided from the units included in the service server 600, to the systems connected to the service server 600.

A service user DB 402, according to an embodiment of the present invention, stores and manages information about subscribers who have subscribed to services and information about service users designated by the subscribers so as to provide 3G-related reception status information and 3G content to designated calling parties.

A video communication reception status DB 403 stores and manages video communication reception availability information, which is set after grouping virtual calling parties by a service subscriber using a terminal or the recording medium of the Internet network 800.

When the service subscriber registers 3G content based on the calling party groups using the terminal or the recording medium of the Internet network 800, a 3G content DB 404 stores and manages the content.

An SMS message processing unit 405 generates an SMS message including supplementary information, such as the video communication reception availability information, 3G content-related information, including information about an address in which 3G content is stored, and the mobile identification number of a called subscriber, in compliance with a specific standard.

An SMS message transmission unit 406 transmits an SMS message generated by the SMS message processing unit 605 to the mobile identification number of a designated calling user through the SMSC 700.

A data processing unit 407, when a service user attempts to access specific content using the terminal or the recording medium of the Internet network 800, performs a process of enabling the corresponding content to be accessed in response to the access request, and then performs a process of enabling a corresponding unit to store information input by the user.

A data transmission unit 408 transmits the information processed by the data processing unit 407 to the terminals of the calling and called parties or the recording medium of the Internet network 800 through the PDSN 350 or the Internet network 800.

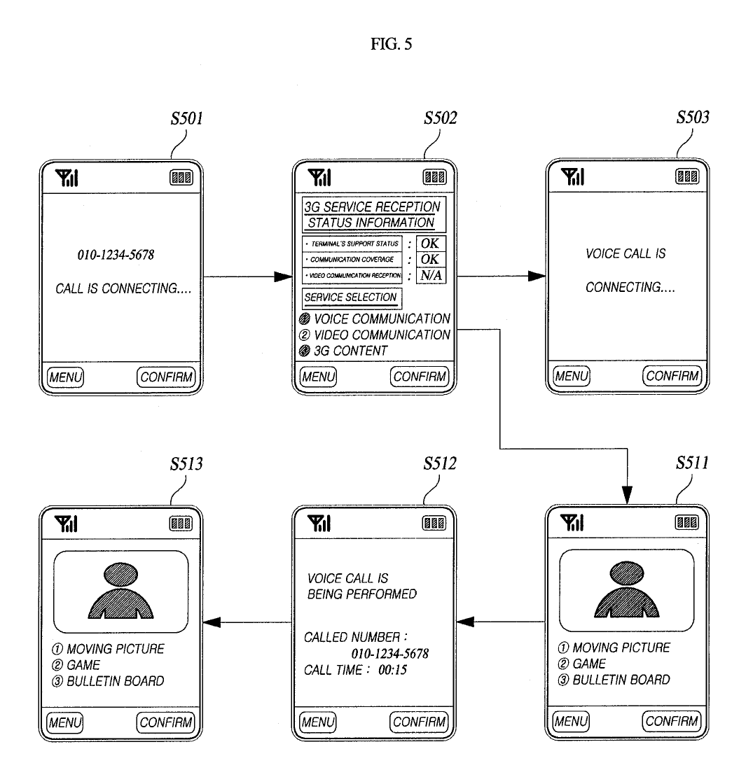

FIG. 5 is a flowchart showing the operational process of a terminal according to an embodiment of the present invention.

According to the present embodiment of the present invention, when a service user attempts a voice call or a video call at step S501, the service server 600 that received a request from the HLR 500 transmits an SMS message, which includes reception status information related to the use of 3G services and 3G content-related information, previously registered by a called party, to the calling terminal 100. The calling terminal 100, which received the SMS message, provides the 3G-related reception status information and a service menu supported by it to the screen of the terminal in compliance with the defined procedure of an installed program.

The reception status information includes the called terminal's 3G service availability information, 3G coverage present availability information, and called party's video communication reception availability information.

Based on the information, the program of the calling terminal 100 determines whether to support video communication and 3G services, and activates the menu of the 3G services to be supported, thereby enabling a calling party to use the menu at step S502. If setting is made such that video communication reception is not possible in the state in which a service subscriber cannot use video communication, a video communication menu is inactivated, so that the calling party cannot use the menu. Here, if the calling party selects voice communication, the calling terminal 100 sends a voice call at step S503.

Further, in the case in which the calling party selects the use of 3G content at step S502, the calling terminal 100 accesses the 3G content located in the service server 600 based on information about the address of the 3G content included in the SMS message at step S511. Thereafter, the calling terminal sends a voice call to the called number, with the result that a call path is connected between calling and called terminals based on the voice call processing procedure of the mobile switching center 400, so that voice communication is realized at step S512. When the 3G content is provided to the calling terminal 100 through the above-described procedure, the calling party, which is using the voice communication, selectively uses the 3G content on a screen using a multi-tasking key provided on a 3G terminal at step S513.

Although the preferred embodiments of the present invention have been disclosed, various modifications are possible without departing from the scope of the invention. Therefore, it will be apparent that the scope of the patents of the present invention is not determined by the above-described embodiments but includes all equivalents and claims.

1. A method of providing third-generation (3G) communication services using Short Message Service (SMS) messages, comprising:
a first step of, when there is a request for a communication call to a specific called terminal by a calling terminal, a service server constructing an SMS message which includes the called terminal's reception information and 3G content information, and transmitting the SMS message to the calling terminal;
a second step of the calling terminal displaying the called terminal's reception information, and activating and displaying supportable service items among service items including voice communication, video communication, and 3G content; and
a third step of, when the voice communication is selected from the service items, performing the voice communication with the called terminal, when the video communication is selected, performing the video communication with the called terminal, and, when the 3G content is selected, accessing the service server in which corresponding 3G content is located, transmitting and receiving packet data and performing voice communication with the called terminal.

2. The method according to claim 1, wherein the first step comprises:
a step of the calling terminal requesting a communication call from the specific called terminal;
a step of a Home Location Register (HLR) inquiring about the called terminal's reception information and providing it to the service server; and
a step of the service server constructing an SMS message which includes the called terminal's video communication reception availability information which is internally registered, 3G content information and the received reception information, and then transmitting the SMS message to the calling terminal.

3. The method according to claim 2, wherein the SMS message is transmitted through a traffic channel connected between a base station and the calling terminal when the calling terminal sends a call.

4. The method according to claim 1, further comprising, when the 3G content is selected at the third step:
a step of the calling terminal accessing the service server in which the 3G content is located based on address information included in the 3G content information;
a step of the calling terminal performing voice communication with the called terminal; and
a step of the calling terminal transmitting and receiving packet data to and from the service server.

5. The method according to claim 1, further comprising, when the 3G content is selected at the third step:
a step of the calling terminal accessing the service server in which the 3G content is located based on address information included in the 3G content information;
a step of the service server transmitting the SMS message, including the 3G content information, to the called terminal;
a step of the calling terminal performing the voice communication with the called terminal;
a step of the calling terminal accessing the service server in which the 3G content is located based on address information included in the 3G content information; and
a step of the calling terminal and the called terminal transmitting and receiving packet data to and from the service server, respectively.

6. The method according to claim 1, wherein the request for a communication call includes a request for a voice call and a request for a video call.

7. The method according to claim 1, wherein the reception information includes the called terminal's 3G service support availability information and 3G coverage availability information.

8. The method according to claim 1, wherein, at the first step, the SMS message further comprises the called terminal's video communication reception availability information.

9. The method according to claim 1, wherein, at the second step, the calling terminal displays reception information including the called terminal's video communication reception availability information.

10. The method according to claim 1, wherein, at the second step, the calling terminal does not activate the service items corresponding to the video communication and the content service when the called terminal does not support 3G services, and does not activate the service item corresponding to the video communication when the called terminal supports the 3G services but cannot receive the video communication.

11. A system for providing 3 G communication services using SMS messages, comprising:
a called terminal for performing voice communication, video communication and data communication with a calling terminal;
an HLR for storing reception information including the called terminal's 3G service support availability information and 3G coverage availability information;
a service server for constructing an SMS message including the called terminal's video communication reception availability information, the called terminal's reception information and 3G content information, and then transmitting the SMS message to the calling terminal; and
a calling terminal for, when the SMS message is received, displaying the called terminal's video communication reception availability information and the reception information by running an installed program, also activating and displaying one or more supportable service items among service items which include voice communication, video communication and 3G content, and providing voice communication, video communication, or 3G content services for the called terminal in response to selection of one of the service items.

12. The system according to claim 11, wherein the service server comprises:
a service user Database (DB) for storing information about users who have subscribed to 3G services;
a video communication reception status DB for storing user terminals' video communication reception availability information;
a 3G content DB for storing 3G content registered by the users;
an SMS message processing unit for generating an SMS message which includes video communication reception availability information, 3G content information, and a called terminal's reception information;
an SMS message transmission unit for transmitting the generated SMS message to a designated calling terminal through an SMS Message Center (SMSC);
a data processing unit for performing interfacing for access processing when the calling terminal or the called terminal attempts to access the 3G content;
a data transmission unit for transmitting data, on which the access processing is performed by the data processing unit, to the calling terminal or the called terminal; and
a central controller for transmitting and receiving information to and from the HLR and the SMSC by processing interfacing therebetween, and performing transmission control on the SMS message.
